(19) United States
(12) Patent Application Publication
(10) Pub. No.: US 2021/0055140 A1
(43) Pub. Date: Feb. 25, 2021

(54) REMOTE DEPLOYMENT OF A DEVICE

(71) Applicant: G.M AFCON SECURITY TECHNOLOGIES LIMITED PARTNERSHIP, Petah Tikva (IL)

(72) Inventor: Gil MALEC, Tel Mond (IL)

(21) Appl. No.: 16/954,254

(22) PCT Filed: Dec. 20, 2018
(86) PCT No.: PCT/IL2018/051382

§ 371 Date: Jun. 16, 2020

Related U.S. Application Data
(60) Provisional application No. 62/608,030, filed on Dec. 20, 2017.

(51) Int. Cl. G01D 11/30

(52) U.S. Cl. CPC G01D 11/305; G01V 1/001

(57) ABSTRACT

A device comprising a base plate dimensioned for insertion into a passageway along an insertion axis; a resilient element comprising a resilient arm disposed about said base plate along said insertion axis, said resilient arm having a first end portion secured to said base plate and a second end portion oriented towards said insertion axis, wherein said second end portion is normally spaced apart from said base plate and capable of being resiliently moved toward the base plate to define a closed position of said resilient element; and a locking element configured for releasably locking said resilient element in the closed position.

### FIELD OF THE INVENTION

The present invention relates to the field of the delivery and deployment of devices in narrow spaces and passageways, such as inside narrow shafts or ground bores.

### BACKGROUND

Perimeter security systems typically include a security boundary installed along a border to be guarded against intrusion, e.g., via tunneling. Such security systems may comprise one or more detection sensors embedded above and/or in the ground at predetermined intervals along the boundary. The sensors may be, e.g., seismographic or any other types of sensors capable of detecting vibrations or movement in the ground.

The detection sensors are typically inserted into shafts, such as hollow fence posts, or into bores in the ground at desired depths. The shafts or bores may be simple vertical holes drilled in the ground, or in some cases, comprise hollow metal or other posts or sleeves inserted down such drilled holes. The design and layout of such systems need also provide for the later retrieval of the devices for periodic inspection and maintenance, such as replacing power sources or repairing malfunctioning units.

It will be appreciated that, in the case of border security systems installed in hostile environments, installation and maintenance work may expose personnel to dangers inherent in the environment. Therefore, the ability to rapidly and effectively deploy and retrieve sensing devices inside such ground bores or shafts may help minimize the time physically spent by maintenance crews in hostile environments, while conducting installation and maintenance work.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a device comprising a base plate dimensioned for insertion into a passageway along an insertion axis; a resilient element comprising a resilient arm coupled to said base plate, said resilient arm being disposed about said base plate along said insertion axis, said resilient arm having a first end portion secured to said base plate and a second end portion oriented towards said insertion axis, wherein said second end portion is normally spaced apart from said base plate and capable of being resiliently moved toward the base plate to define a closed position of said resilient element; and a locking element configured for releasably locking said resilient element in the closed position.

In some embodiments, the resilient element is a resilient clip comprising a first arm and a second arm, wherein said first arm and said second arm are resiliently interconnected at a first end thereof and spaced apart at a second end thereof, and wherein said first arm is coupled to said base plate along said insertion axis.

In some embodiments, each of said first arm and said second arm further comprises an inwardly-oriented reverse-turned section at the second end thereof.

In some embodiments, said locking element is a ring clamp configured for engaging said reverse-turned sections of said first arm and said second arm in said closed position.

In some embodiments, said ring clamp is coupled to a pulling means configured for remotely releasing said ring clamp.

In some embodiments, the base plate is attached to an insertion means for inserting the device to a desired location within the passageway.

In some embodiments, the insertion means further comprises a stop member configured for engaging an insertion point of said passageway.

There is also provided, in accordance with an embodiment, a method comprising providing a passageway; providing a device comprising a base plate dimensioned for insertion into a passageway along an insertion axis, a resilient element comprising a resilient arm coupled to said base plate, said resilient arm being disposed about said base plate along said insertion axis, said resilient arm having a first end portion secured to said base plate and a second end portion oriented towards said insertion axis, wherein said second end portion is normally spaced apart from said base plate and capable of being resiliently moved toward the base plate to define a closed position of said resilient element, and a locking element configured for releasably locking said resilient element in the closed position; locking said resilient element in said closed position using said locking element; inserting said device into said passageway along said insertion axis; and releasing said locking element upon said device reaching a desired location within said passageway.

In some embodiments, the resilient element is a resilient clip comprising a first arm and a second arm, wherein said first arm and said second arm are resiliently interconnected at a first end thereof and spaced apart at a second end thereof, and wherein said first arm is coupled to said base plate along said insertion axis.

In some embodiments, each of said first arm and said second arm further comprises an inwardly-oriented reverse-turned section at the second end thereof.

In some embodiments, said locking element is a ring clamp configured for engaging said reverse-turned sections of said first arm and said second arm in said closed position, wherein said releasing comprises remotely releasing said ring clamp using pulling means.

In some embodiments, the base plate is attached to an insertion means for inserting the device to a desired location within the passageway.

In some embodiments, said insertion means is a line, said passageway is vertical, and said inserting comprises lowering said device into said passageway using said line.

In some embodiments, said insertion means further comprises a stop member configured for engaging an insertion point of said passageway.

There is further provided, in accordance with an embodiment, a system comprising at least one device comprising a base plate dimensioned for insertion into a passageway along an insertion axis, and a resilient element comprising a resilient arm coupled to said base plate, said resilient arm being disposed about said base plate along said insertion axis, said resilient arm having a first end portion secured to said base plate and a second end portion oriented towards said insertion axis, wherein said second end portion is normally spaced apart from said base plate and capable of being resiliently moved toward the base plate to define a closed position of said resilient element; a locking element configured for releasably locking said resilient element in the closed position; and insertion means coupled to said at least one device, said insertion means being configured for inserting said at least one device to a desired location within the passageway.

In some embodiments, the passageway is vertical, and said insertion means is a line configured for lowering said at least one device into said passageway.

In some embodiments, a proximal end of the line further comprises a stop member configured for engaging an insertion point of said passageway, and the length of the line is equal to the distance between the insertion point of said passageway and said desired location.

In some embodiments, the resilient element is a resilient clip comprising a first arm and a second arm, and said first arm and said second arm are resiliently interconnected at a first end thereof and spaced apart at a second end thereof, wherein said first arm is coupled to said base plate along said insertion axis.

In some embodiments, each of said first arm and said second arm further comprises an inwardly-oriented reverse-turned section at the second end thereof.

In some embodiments, said locking element is a ring clamp configured for engaging said reverse-turned sections of said first arm and said second arm in said closed position, wherein said ring clamp is coupled to a pulling means configured for remotely releasing said ring clamp.

In some embodiments, the system further comprises two or more said devices, wherein said two or more devices are deployed along a length at specified intervals. In some embodiments, each of said devices further comprises one or more detecting sensors for detecting the presence of an intruder, wherein said detecting sensors are each configured for generating a signal having a value which is correlated with a distance of said intruder from said detecting sensor. In some embodiments, the system further comprises a control unit configured for determining a location of an object relative to each of said sensors based, at least in part, on a difference in said value between two or more said detecting sensors.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIGS. 1A-1B illustrate perspective views of an exemplary device, according to an embodiment of the present disclosure;

FIGS. 1C-1D illustrate side views of an exemplary device, according to an embodiment of the present disclosure;

FIGS. 2A-2B illustrate side views of an exemplary device deployed in a passageway, according to an embodiment of the present disclosure;

FIG. 2C illustrates a perspective view of an exemplary deployed in a passageway, according to an embodiment of the present disclosure;

FIG. 3 illustrates a system for delivering and deploying two or more devices for remote deployment of a device, according to an embodiment of the present disclosure; and

FIG. 4 illustrates a system configured for determining a horizontal and/or vertical location of a target, according to an embodiment of the present disclosure.

### DETAILED DESCRIPTION

There is disclosed a device, a system and a method for remotely retrievably deploying and securing a device, such as a sensor device for a border security system, at a desired location within a narrow or hard-to-reach passageway, such as ground bore or shaft. The following discussion shall focus on the application of exemplary embodiments of the present disclosure in the area of perimeter security systems, such as in-the-ground border anti-tunneling security systems. However, it is readily appreciated that the present device, system and method may lend themselves to numerus other applications involving the remote placement and securement of one or more devices at inaccessible areas of, for example, relatively small diameter pipes, conduits, and the like.

In an exemplary embodiment, the present device comprises a base plate dimensioned for insertion into a narrow passageway along an insertion axis. The base plate may comprise a plurality of openings and/or attachment means for attaching one or more devices such as a sensor device thereto, for delivery to and deployment at the desired location.

To the base plate there is coupled a resilient element, which comprises a resilient arm. The resilient arm has a first end portion secured to the base plate and a second end portion normally spaced apart from the base plate, thereby defining an open position of the resilient element. The resilient arm is capable of being resiliently moved toward the base plate, thereby defining a closed position of the resilient element. The resilient element is disposed about the base plate such that the resilient arm is coincident with the insertion axis; the second end portion is oriented towards the insertion axis; and the plane of movement of the resilient arm between the open and closed positions is substantially perpendicular to the base plate plane.

There is also provided a locking element for releasably engaging the resilient element in the closed position, said locking element being configured for remote release, upon which release the resilient arm is resiliently moved to the open position.

The device is configured for inserting into a narrow passageway when the locking element is engaged and the resilient element is in the locked position, thus enabling the device to move freely along the length of the passageway. For example, the device may be lowered from a flexible line under gravity into a hollow upright post, pipe, cavity, shaft, ground bore, and/or the like. Once the device has reached a desired location or depth along the length of the passageway, the locking element is remotely released, such that the resilient arm is moved to the open position whereby the resilient arm exerts a lateral force against an interior area of the passageway. Such lateral force urges the base plate against an opposing area of the interior of the passageway, thus frictionally securing the device at the desired location within the passageway. The force exerted by the resilient arm against the interior of the passageway is configured to provide sufficient friction to resist axial as well as lateral displacements of the device under normal forces of, e.g., gravity and vibrations.

In some embodiments, the second end portion of the resilient element is oriented towards the insertion axis, thus providing for greater resistance to displacement of the device in that direction, because such displacement attempt will tend to urge the resilient arm to move further away from the base plate, thus increasing the frictional force exerted by the base plate against the interior of the passageway. Accordingly, for example, in the case of a vertical shaft, the deployed device will offer greater frictional resistance to attempts at downward displacement. Conversely, the device offers lesser frictional resistance to displacement in the opposite direction, so as to facilitate retrieval of the device by pulling it back in the reverse direction, towards the insertion point. In such case, downward movement tends to further spread the resilient arm, thus increasing the force/friction, while upward movement tends to close the resilient arm, thus decreasing the force/friction. Accordingly, the device may be easily pulled upwards even when the locking arm is released.

Optionally, the device is coupled to insertion means for advancing or delivering the device to its destination location within the passageway, which may at a later time be used for retrieval of the device. Such insertion means may be a flexible line used for lowering the device under gravity into a location in a vertical shaft, ground bore, pipe, and/or passageway; or otherwise a pushing member, such as a rigid or semi-rigid rod for advancing the device along a desired path.

In some embodiments, advantageously, a distal end of the insertion means is fixedly coupled to the device, while a proximal end is retained about the insertion point, thus permitting the later retrieval of the device, e.g., for maintenance or repair. Advantageously, the insertion means further comprises a stop member at the proximal end thereof, such as a crossbar, a hook, or a catch, configured to engage an element of the opening of the passageway, so as to secure the proximal end of the insertion means about the insertion point, and limit the excursion of the device into the passageway. Optionally, the length of the insertion means may be configured for precise delivery of the device to a desired location.

Thus, for example, in the case of multiple device to be deployed in a plurality of locations, e.g., a plurality of ground bores along a security perimeter, there may be prepared in advance a plurality of device coupled to desired lengths of a flexible line. The flexible lines may each comprise a stop member, such as a crossbar or a catch, at a proximal end thereof. Deployment may then be effected rapidly and simply by lowering each such device from its respective flexible line until the stop member engages the opening of the ground bore, thus indicating that the device has reached its desired depth. The locking element may then be released, so as to secure the device in place.

There is further disclosed a system for simultaneously delivering and deploying two or more devices along the length of a passageway. Such system may be effected, for example, by fixedly coupling two or more device as disclosed above at desired intervals along a flexible line. The flexible line may then be lowered into a shaft or a hollow passageway. Once the two or more device have reached their respective desired locations/heights, their respective locking elements are released, such that the two or more device are secured in place in the manner described above. The two or more device may later be retrieved from the passageway by pulling the flexible line in the opposite direction.

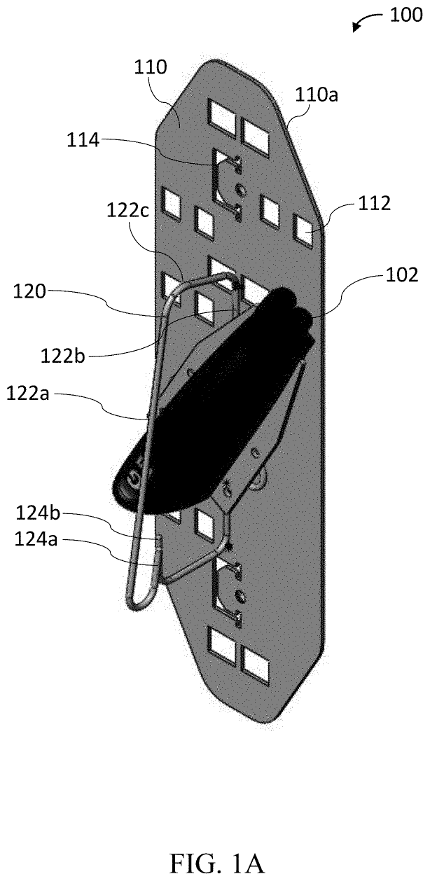

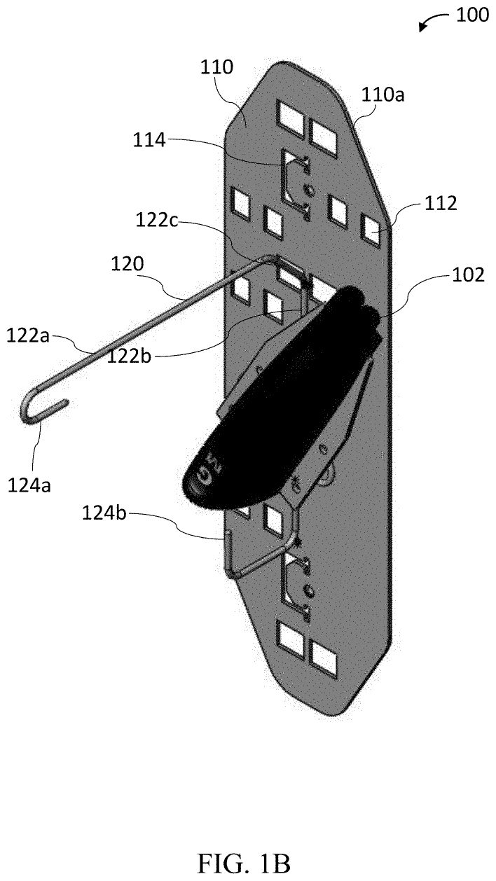

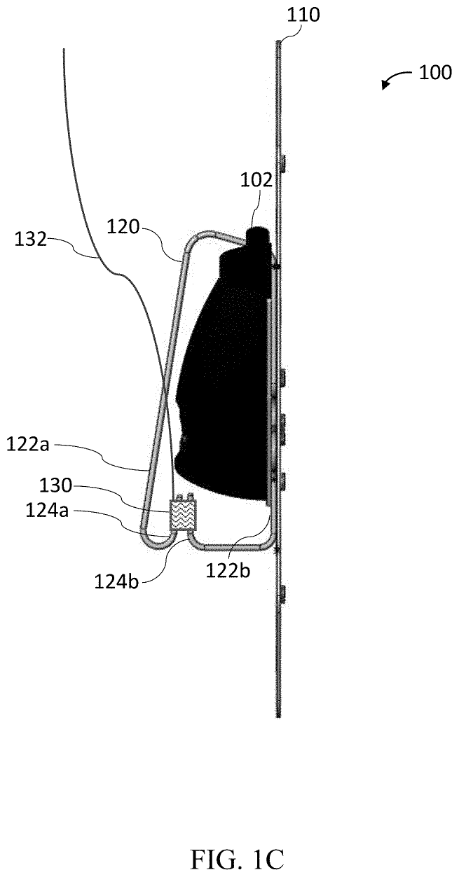

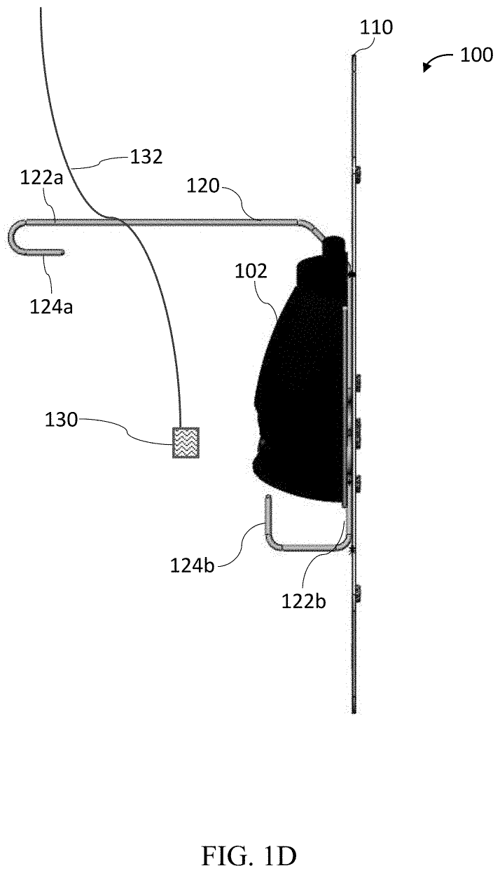

FIGS. 1A and 1B are perspective views of an exemplary embodiment of a device 100 according to the present disclosure. A base plate 110 defines a substantially planar plate comprising a plurality of openings 112 configured for attachment of one or more devices, such as sensor device 102, to be delivered to a deployment location. Base plate 110 further comprises one or more openings 114 configured for fixedly attaching, e.g., a flexible line. It will be appreciated that the embodiment of base plate 110 depicted in FIGS. 1A and 1B is given for exemplary purposes only, and that other shapes and dimensions of base plate 110 may be used, depending on the specific application and the dimensions and cross-sectional profile of the passageway in question. Base plate 110 may be made of any appropriate material, e.g., steel, aluminum, polymer, or a combination thereof. Optionally, a back 110a of base plate 110 may be coated in, e.g., rubber or another similar high-friction material, to increase its purchase on the interior wall of the passageway. Base plate 110 may be designed to carry, or be attached to, any device or object, e.g., a sensor, a canister for slow release of a substance, an illumination device, and the like.

In this embodiment, the resilient element may be clip 120, shown in a closed position in FIGS. 1A and 1n an open position in FIG. 1B. Clip 120 may define a U-shaped body comprising a pair of arms 122a and 122b connected at a closed end of the U-shaped body by a flexibly resilient region 122c. In this embodiment, clip 120 is disposed about base plate 110 such that arm 122b is coupled substantially along its length to base plate 100, and clip 120 defines a plane that is perpendicular to a plane defined by base plate 110. It will be appreciated that, in some embodiments, clip 120 may be disposed in other orientations and directions about base plate 120, depending on the specific application and the dimensions and cross-sectional profile of the passageway in question. Clip 120 may be made as an integral member, such that it is resilient along its length, of a material such as a resilient metal wire, rod, or band, or another suitable material. Alternatively, clip 120 may be constructed such that area 122c alone may comprise resilient properties. In some variations, section 122c of clip 120 may comprise a resilient or spring-loaded hinged joint to which arms 122a, 122b are coupled. Optionally, areas of clip 120 configured for coming in contact with the interior wall of the passageway may be coated in, e.g., rubber or another similar high-friction material, to increase their purchase on the interior wall of the passageway.

It will be appreciated that the embodiment of clip 120 shown in FIGS. 1A and 1B is for exemplary purposes only, and that other shapes may also be used, such as triangular, arcuate, or otherwise. In some variations, more than one resilient element may be used. In other variations, the resilient element may comprise one arm, or more than two arms. In some embodiments (not shown), the resilient element may be formed integrally with the base plate, be embedded in the base plate, or be coupled to the base plate by a resilient or spring-loaded hinged joint.

Arms 122a, 122b may further comprise, at respective terminal ends thereof, inwardly-oriented reverse-turned sections 124a and 124b, configured for facilitating the engagement of arms 122a, 122b by a locking element (not shown), to define a closed position of clip 120.

FIGS. 1C and 1D show, respectively, a side view of the device 100 with clip 120 in a closed position and an open position. In FIG. 1C, locking element 130 is, e.g., a clamp configured for engaging sections 124a, 124b of arms 122a, 122b in close proximity. Flexible string tether 132 is attached to locking element 130, to facilitate the remote release thereof, e.g., by pulling on string tether 132, thereby slideably removing locking element 130 from sections 124a, 124b. String tether 132 may be made of any suitable flexible material, such as plastic or metal wire string.

Advantageously, sections 124a, 124b are oriented such that locking element 130 is slideably removable in a direction opposite the axis of insertion of the device 100, i.e., by pulling on string tether 132 from the point of insertion of the passageway. String tether 132 advantageously has a length configured for spanning at least the area between the point of insertion and the location of device 100, to enable the remote release of locking element 130 from said insertion point.

Once locking element 130 is removed, clip 120 resiliently moves into the open position, as shown in FIG. 1D. It will be appreciated that numerous other configurations of locking elements and mechanisms may be used to facilitate the engagement and remote release of clip 120. For example, the locking element may comprise any suitable remotely-removable mechanical fastener, clasp, or clamp. The locking element may also comprise electric, piezoelectric, electro-mechanical, or electro-magnetic actuation, and may further comprise electronic remote control means for remote actuation of the release thereof.

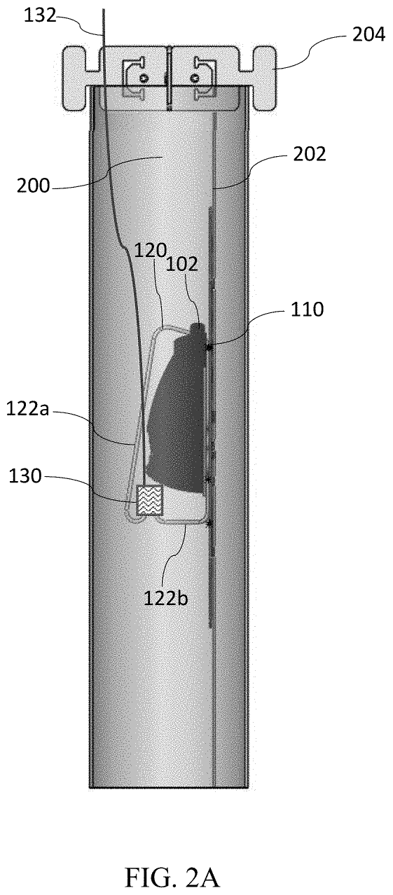

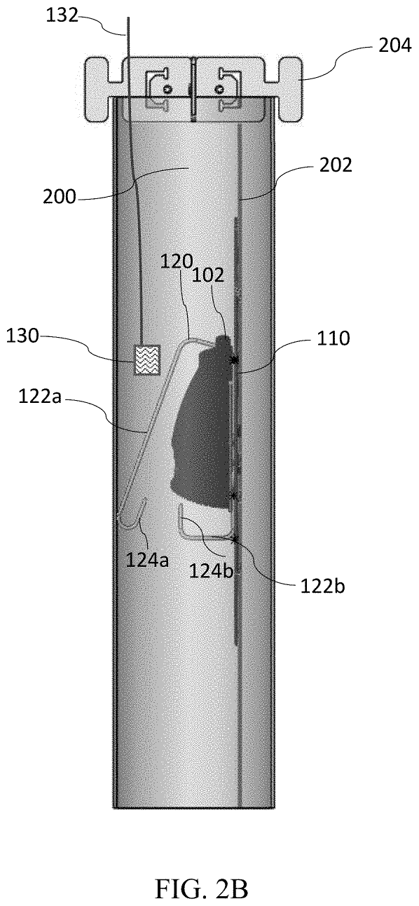

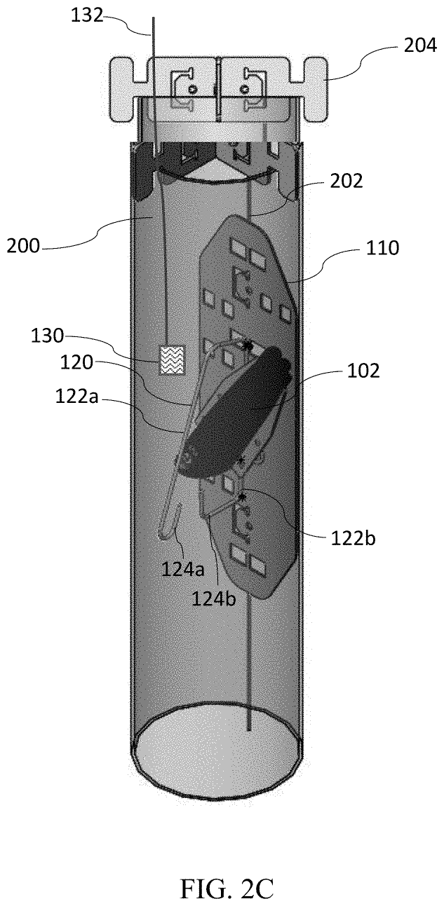

FIGS. 2A-2C show the device deployed inside a passageway 200 (in this variation, a vertical ground bore). In FIG. 2A, the device is lowered on flexible line 202 into the passageway 200. Line 202 may be made of any suitable material, such as a metal wire or synthetic wire. Alternatively, Line 202 may comprise, e.g., a sequence of rigid or semi-rigid jointed rods. Advantageously, flexible line 202 may be coupled to stop member 204 such that it remains suspended from an insertion point of passageway 200, for precise delivery and future retrieval of the device. Once the device has reached a desired location inside passageway 200, as shown in FIGS. 2B and 2C, string tether 132 is pulled (or another release mechanism is activated), thus slideably removing locking element 130 and permitting clip 120 to move to the open position, whereby arm 122a resiliently engages an interior wall of passageway 200. Retrieval of the device may be effected by pulling on flexible line 202 in a direction opposite the axis of insertion. As noted above, the orientation of clip 120 ensures that there is lesser resistance to displacement in the direction that is opposite to the axis of insertion.

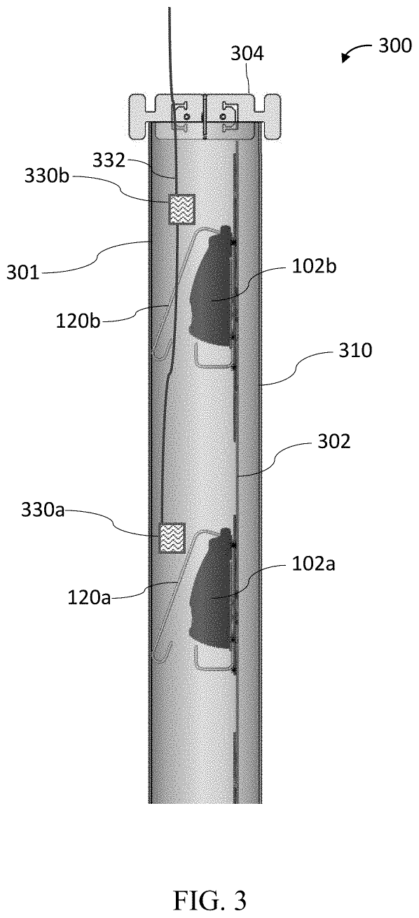

FIG. 3 shows an exemplary embodiment of a system 300 for simultaneous delivery and deployment of two or more device inside a passageway. System 300 comprises two or more device 102a and 102b coupled along flexible line 302 at desired intervals. The line 302 is lowered into passageway 301 and remains suspended from stop member 304. String tether 332 is coupled to locking elements 330a and 330b, and configured to provide for the release of two or more locking elements at once with a single simple pull of string tether 332. Once the device 102a, 102b have reached their respective destination locations along the height of passageway 301, string tether 332 is pulled, thereby slideably removing locking elements 330a and 330b, and releasing clips 120a, 120b into their open positions.

Alternatively, locking elements 330a, 330b may be configured for release in series. In such case, the order of release of locking elements 330a, 330b may be determined based on the specific application. For example, in the present depiction, locking element 330b may be released first, thus securing device 102b first, to ensure proper placement of the one or more device downstream from device 102b.

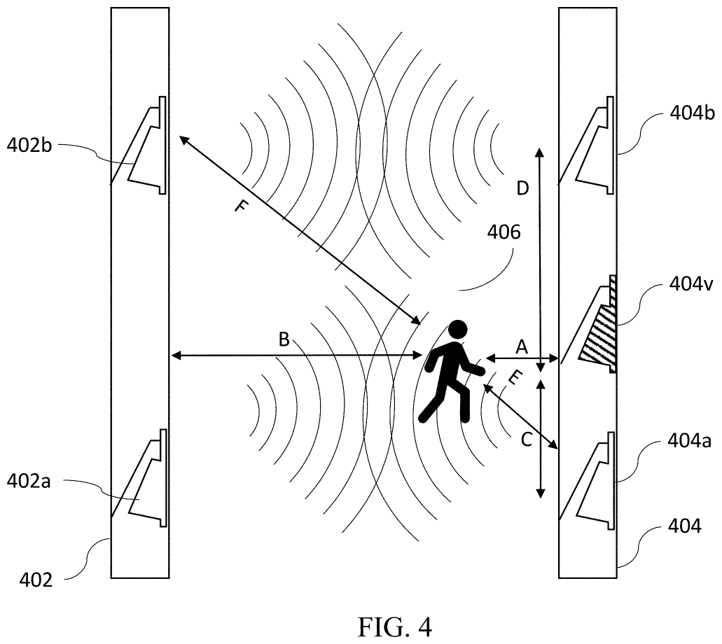

FIG. 4 illustrates an exemplary embodiment of the present invention wherein a perimeter security system is configured for determining a horizontal and/or vertical location of a target along a perimeter. Vertical sensor arrays 402 and 404 are, e.g., perimeter security system sensor arrays having each a plurality of sensors positioned at specified distance intervals in the vertical dimension, wherein said vertical sensor arrays are each located along a perimeter at specified distance intervals. In some embodiments, vertical sensors arrays 402, 404 may comprise fence posts extending above ground. In some embodiments, vertical sensor arrays 402, 404 may comprise bores or shafts extending below ground. When a target, such as an intruder 406, activates one or more of sensors 402a, 402b, 404a, 404b, a central control unit (not shown) may be configured for determining an exact location of intruder 406, based on determining a location of intruder 406 relative to each sensor in a pair of sensors. For example, the central control unit may be configured for determining a horizontal location of intruder 406 between, e.g., sensors 402a, 404a (relative distances A and B). Similarly, the central control unit may be configured for determining a location of intruder 406 in the vertical dimension, e.g., between sensors 404a, 404b (relative distances C and D). In some embodiments, the central control unit may further be configured for determining a location of intruder 406 in a diagonal dimensions, e.g., between sensors 402b, 404a (relative distances E and F). Accordingly, the central control unit may be configured for locating intruder 406 within a two-dimensional area extending horizontally between vertical sensor arrays 402, 404 and vertically along the height of vertical sensor arrays 402, 404.

In each case, the central control unit determines a relative location of intruder 406 between each pair of sensors based, at least in part, on differences between measured values by the pair of sensors. These values may be one or more of signal strength, signal arrival time difference, signal phase, and/or signal propagation direction.

In some embodiments, a determination of a location of intruder 406 by the central control unit may cause an indication to be provided to an operator of the security system. For example, such indication may identify one or more sensors closest to the intruder (e.g., in the case of FIG. 4, the central control unit may identify sensor 404a).

In some embodiments, the central control unit is further configured for creating one or more ‘virtual’ sensors between each pair of sensors, based on the differences between measured values, to provide a more accurate location indication. For example, with continued reference to FIG. 4, the central control unit may create virtual sensor 404v, and identify it as the closest to intruder 406.

It will be appreciated that all the above description and examples have been given for the purpose of illustration and are not intended to limit the invention in any way. The terms, “for example,” “e.g.,” “optionally,” as used herein, are intended to be used to introduce non-limiting examples. While certain references are made to certain example components, other components can be used as well and/or the example components can be combined into fewer components and/or divided into further components. In the description and claims of the application, each of the words “comprise” “include” and “have,” and forms thereof, are not necessarily limited to members in a list with which the words may be associated. In addition, where there are inconsistencies between this application and any document incorporated by reference, it is hereby intended that the present application controls.

1. A device comprising:
a base plate dimensioned for insertion into a passageway along an insertion axis;
a resilient element comprising a resilient arm coupled to said base plate, said resilient arm being disposed about said base plate substantially along said insertion axis, said resilient arm having a first end portion secured to said base plate and a second end that is normally spaced apart from said base plate and capable of being resiliently moved toward the base plate to define a closed position of said resilient element; and
a locking element configured for releasably locking said resilient element in the closed position.

2. The device of claim 1, wherein the resilient element is a resilient clip comprising a first arm and a second arm, wherein said first arm and said second arm are resiliently interconnected at a first end thereof and spaced apart at a second end thereof, and wherein said first arm is coupled to said base plate substantially along said insertion axis.

3. The device of claim 2, wherein each of said first arm and said second arm further comprises an inwardly-oriented reverse-turned section at the second end thereof.

4. The device of claim 3, wherein said locking element is a clamp configured for engaging said reverse-turned sections of said first arm and said second arm in said closed position.

5. The device of claim 4, wherein said clamp is coupled to a pulling means configured for remotely releasing said clamp.

6. The device of claim 1, wherein the base plate is attached to an insertion means for inserting the device to a desired location within the passageway.

7. The device of claim 6, wherein the insertion means further comprises a stop member configured for engaging an insertion point of said passageway.

8. The device of claim 1, wherein said based place further comprises means for attaching one or more detection sensors.

9. A method comprising:
providing a passageway;
providing a device comprising:
a base plate dimensioned for insertion into a passageway along an insertion axis,
a resilient element comprising a resilient arm coupled to said base plate, said resilient arm being disposed about said base plate substantially along said insertion axis, said resilient arm having a first end portion secured to said base plate and a second end portion that is normally spaced apart from said base plate and capable of being resiliently moved toward the base plate to define a closed position of said resilient element, and
a locking element configured for releasably locking said resilient element in the closed position;
locking said resilient element in said closed position using said locking element;
inserting said device into said passageway along said insertion axis; and
releasing said locking element upon said device reaching a desired location within said passageway.

10. The method of claim 9, wherein the resilient element is a resilient clip comprising a first arm and a second arm, wherein said first arm and said second arm are resiliently interconnected at a first end thereof and spaced apart at a second end thereof, and wherein said first arm is coupled to said base plate substantially along said insertion axis.

11. The method of claim 10, wherein each of said first arm and said second arm further comprises an inwardly-oriented reverse-turned section at the second end thereof.

12. The method of claim 11, wherein said locking element is a clamp configured for engaging said reverse-turned sections of said first arm and said second arm in said closed position, and wherein said releasing comprises remotely releasing said clamp using pulling means.

13. The method of claim 9, wherein the base plate is attached to an insertion means for inserting the device to a desired location within the passageway.

14. The method of claim 13, wherein said insertion means is a line, wherein said passageway is vertical, and wherein said inserting comprises lowering said device into said passageway using said line.

15. The method of claim 14, wherein said insertion means further comprises a stop member configured for engaging an insertion point of said passageway.

16. A system comprising:
at least one device comprising:
a base plate dimensioned for insertion into a passageway along an insertion axis, and
a resilient element comprising a resilient arm coupled to said base plate, said resilient arm being disposed about said base plate substantially along said insertion axis, said resilient arm having a first end portion secured to said base plate and a second end portion that is normally spaced apart from said base plate and capable of being resiliently moved toward the base plate to define a closed position of said resilient element, and
a locking element configured for releasably locking said resilient element in the closed position; and
insertion means coupled to said at least one device, said insertion means being configured for inserting said at least one device to a desired location within the passageway.

17. The system of claim 16, wherein the passageway is vertical, and wherein said insertion means is a line configured for lowering said at least one device into said passageway.

18. The system of claim 17, wherein a proximal end of the line further comprises a stop member configured for engaging an insertion point of said passageway, and wherein the length of the line is equal to the distance between the insertion point of said passageway and said desired location.

19. The system of claim 16, wherein the resilient element is a resilient clip comprising a first arm and a second arm, wherein said first arm and said second arm are resiliently interconnected at a first end thereof and spaced apart at a second end thereof, and wherein said first arm is coupled to said base plate along said insertion axis.

20. (canceled)

21. (canceled)

22. (canceled)

23. The system of claim 16, further comprising two or more said devices, wherein said two or more devices are deployed along a length at specified intervals.

24. (canceled)

25. (canceled)
